(19) United States
(12) Patent Application Publication
(10) Pub. No.: US 2025/0318905 A1
(43) Pub. Date: Oct. 16, 2025

(54) A Punch for Creating a Tooth Preparation Tray

(71) Applicant: Carl J. Metz, Scottsdale, AZ (US)

(72) Inventor: Carl J. Metz, Scottsdale, AZ (US)

(21) Appl. No.: 18/635,842

(22) Filed: Apr. 15, 2024

(51) Int. Cl. A61C 7/02

(52) U.S. Cl. CPC A61C 7/02

(57) ABSTRACT

A specially designed punch tool removes an attachment chamber from an attachment creation tray to form a tooth attachment preparation tray. The tool creates at least one opening in the tray that closely matches a planned tooth attachment's position. The tool is designed to be capable of removing any attachment chamber without damage to the resulting preparation tray.

### RELATED APPLICATIONS

This invention is related to U.S. patent application Ser. No. 17/963,111 filed on Oct. 10, 2022. The entire prior application is incorporated by reference.

### STATEMENT OF GOVERNMENT INTEREST

Not applicable.

### BACKGROUND OF THE INVENTION

### (1) Field of the Invention

This invention is directed to improvements in the orthodontic alignment of teeth. In particular, the preparation for the multi-step plastic aligner tray system is improved by adding an additional preparation tray when applying an etch or a bonding adhesive to the surface of a tooth. The disclosed invention simplifies the creation of the preparation tray.

### (2) Description of Related Art

Cosmetic alignment of teeth is common throughout the world. The desire for straight teeth, or a particular aesthetic, is known to date back to ancient times.

A recent advance is the use of clear aligner systems. This method utilizes removable thermoplastic aligner trays in a multi-step process. In this method there are improved oral hygiene benefits and fewer patient issues when compared to metal bands and ceramic bracket systems.

Tooth positioning trays can be fabricated using a variety of methods. Exemplary methods for fabricating sequential aligner trays can be found in numerous patents and patent applications that are assigned to Align Technology, Inc. In particular, sequential alignment trays are vacuum-formed utilizing computerized 3D prints of planned tooth movement.

The multiple aligner tray approach has important benefits. The trays provide orthodontic tooth movement based on a designed progression of steps. Placing the aligner over the teeth provides straightening forces that are designed to move and rotate teeth. By putting successive aligning trays over teeth, forces are gradually applied to malpositioned teeth. The teeth respond by gradually moving and rotating. The trays are typically worn at least 20 hours per day and can be conveniently removed to eat, brush, and floss. A typical number of successive trays might be 20-30, and more if needed.

Initially, plastic aligner trays had limitations on how teeth could be orthodontically moved. A series of progressive aligners had limited control over the amount of tooth movement. Over the years, this has been improved by incorporating tooth attachments that are bonded to a tooth by an adhesive. Successive aligner trays engage the tooth attachments in order to achieve better control and larger tooth movements.

The tooth attachments are created and bonded to the teeth of each patient. The geometries and locations of the tooth attachments vary based on the patient's needs. The bonding process requires that the tooth is etched and bonding fluids applied. Unfortunately, the method of applying the etch and bonding fluids is difficult to control. The clinician manually places the etching fluid on the tooth surface and the amount is difficult to control. If too much is applied, it must be cleaned up. Excessive etching damages the tooth surface, even if the tooth is wiped immediately after an accidental misapplication. If the tooth receives enough damage, the clinician must repair the unnecessary damage.

The tooth damage is minimized by including a preparation tray with holes that confine the etch and bonding fluids to the attachment area as described by U.S. patent application Ser. No. 17/963,111 filed on Oct. 10, 2022.

However, the creation of a preparation tray with holes is difficult. The sequential alignment trays are made by vacuum molding over a platform of sequential 3D printed alignment teeth according to the designed movement. A vacuum molding process is not designed to create holes and cannot be reasonably adapted to do so.

The preparation tray can be manufactured by creating the holes in a copy of the tooth attachment creation tray, or a similar tray with defined tooth attachment contact areas which match the planned tooth attachments for that patient.

### SUMMARY OF THE INVENTION

A specially designed punch tool removes an attachment chamber from an attachment creation tray thus converting the attachment creation tray into a preparation tray. The tool creates at least one opening in the attachment creation tray that closely matches a future tooth attachment contact area. The tool is designed to be capable of removing any attachment chamber, including those located in areas inaccessible to other punch tool designs.

### BRIEF DESCRIPTION OF FIGURES

FIG. 1 shows an attachment creation tray with protruding chambers used to form tooth attachments.

FIG. 2A shows a simple punch useful for removing only some attachment chambers.

FIG. 2B is a detailed view of the punch jaw overhang.

FIG. 3A shows a simple embodiment where a hemostat is adapted to provide a manual punch and die.

FIGS. 3B-3D are detailed views of punch jaw overhang.

FIG. 4 shows a preferred embodiment of a manual punch and die.

FIG. 5 is a detailed view of the die overhang.

FIGS. 6A-6E show another design where a manual punch has interchangeable punch geometries by using an attachable punch/die set.

FIG. 7 shows examples of punch/die geometries.

FIG. 8A shows how the punch tool is positioned in an attachment creation tray to punch out an attachment chamber.

FIG. 8B shows the punch tool where the punch is engaged with the die after cutting out an attachment chamber.

FIG. 8C is a right side view of the punch tool in FIG. 8B.

FIG. 8D shows how the punch indexes the internal surface of the attachment chamber to ensure correct positioning.

FIG. 8E is a closeup of the punch and die engaging the attachment chamber using exemplary geometry.

FIG. 9 is a closeup photograph of preparation tray holes created with a dental drill.

FIG. 10 is a closeup photograph of preparation tray holes created with a punch.

### DETAILED DESCRIPTION OF THE INVENTION

A preparation tray is created by using a manual removal process to create one or more holes in an attachment creation tray or similar appliance indexed with locations and geometries of future tooth attachments. The preparation tray is designed to fit over a patient's teeth prior to the placement of one or more tooth attachments used during tooth alignment. The hole(s) should match the location, orientation, and geometry of a future tooth attachment's contact area with the tooth. This prevents bonded flashing by restricting the bonding of the material used to create the attachment to the attachment contact area. Any flash beyond the attachment contact area will be unbonded and easily removable with hand instruments. The holes can be created either at the dental office or by the manufacturer of the tooth aligner trays.

The alignment trays are made by vacuum forming, as already mentioned, with an average plastic thickness of about 0.6 mm thick after being formed. (See Micro computed tomography evaluation of Invisalign aligner thickness homogeneity, Angle Orthod (2021) 91 (3): 343-348. doi.org/10.2319/040820-265.1) This makes it relatively easy for a lightweight punch tool to remove small areas from the tray.

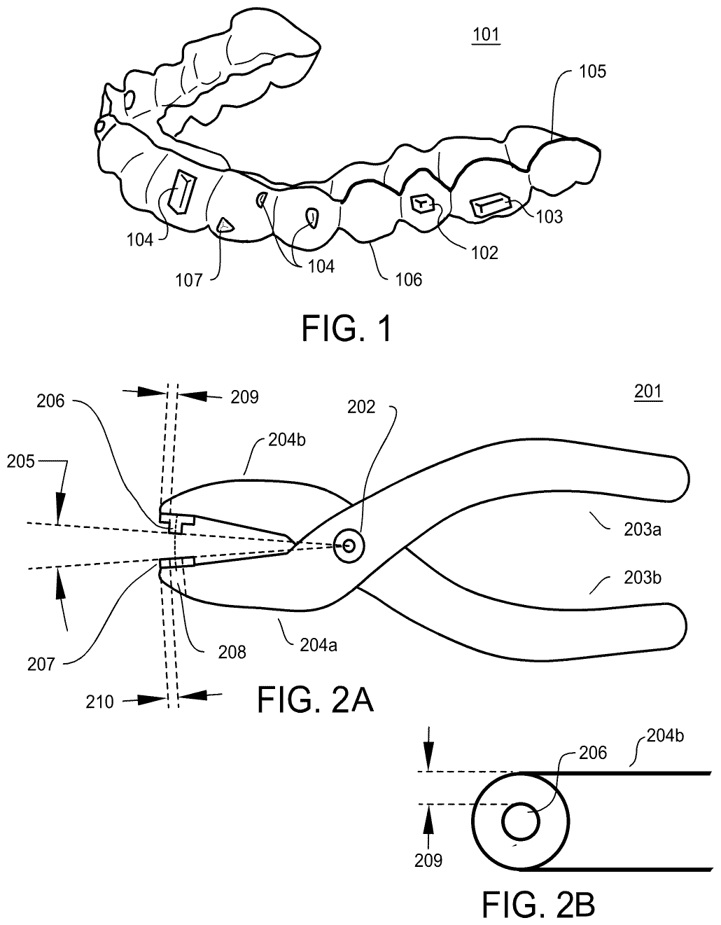

FIG. 1 shows an attachment creation tray 101 just before the holes are created to convert it into a preparation tray. Tooth attachment chambers can be divided into two groups: Readily accessible and inaccessible. Readily accessible attachment chamber positions 102 are located near the gingival edge 105 of the attachment creation tray on wide posterior teeth. Inaccessible attachment chambers include deep attachment chamber positions 103 in close proximity to the occlusal or incisal surface 106 of the attachment creation tray, and anterior attachment chamber positions 104 located on incisors and cuspids.

Both deep and anterior attachment chambers are inaccessible for a punch tool to accurately remove the protruding attachment chamber in a single stroke, but for different reasons. A normal punch, whose punch jaw extends beyond the punch in length and width, cannot be positioned within deep attachment chambers 103 because the punch jaw overhang contacts the internal occlusal/incisal surface and stops the punch short of the necessary depth to do so. A normal punch, whose punch jaw is thicker than human anterior teeth (incisors and cuspids), cannot be positioned within anterior attachment chamber positions 104 without stretching the attachment creation tray to do so. Some attachment chamber positions are deep on anterior teeth 107, further complicating the process of removing them with a punch.

Current punch tools are incapable of precisely removing inaccessible attachment chambers without flattening the 3D attachment creation tray to gain proper access. Any attempt to do so would easily damage the semi-rigid plastic attachment creation tray by stretching the material beyond its ability to rebound to its correct dimensions or cracking it. If an attachment creation tray is damaged during the process of its conversion to a preparation tray, its accuracy and effectiveness are diminished. FIG. 2A further highlights this problem.

In FIG. 2A, a punch tool 201 includes a die handle 203a and punch handle 203b connected to die jaw 204a and punch jaw 204b by a pin with bushing 202. The spread angle 205 of the jaws is based on the maximum movement of the handles and jaws. A punch 206 is positioned near the end of the punch jaw, however the punch jaw extends beyond the punch 209 in length and width creating punch jaw overhang.

Similarly, a matching die 207 is positioned near the end of the die jaw, and die jaw overhang 210 is created by the position of the die and size of the die jaw. Due to the geometry of the die jaw, a tapered slug passage 208 is designed to allow the slug from the punch operation to pass through.

FIG. 2B is a top view of the punch jaw 204b of the punch tool 201 showing punch jaw overhang 209 extends beyond the punch in both width and length.

The punch tool of FIG. 2A has limitations for positioning the punch geometry in an attachment chamber. A large, stiff punch tool ill-fits the geometry of the attachment creation tray. The punch jaw is overly large in length and width, preventing the punch from indexing into deep attachment chambers near the terminal depth of the attachment creation tray. The punch jaw is overly large in thickness, preventing the punch from indexing into anterior attachment chambers. Forcing the punch of FIG. 2A into these inaccessible attachment chambers would stretch and distort the attachment creation tray, possibly irreversibly. This distortion would lead to a poor fitting preparation tray with inaccurate hole positions and shapes.

Using the punch tool of FIG. 2A to create holes as close as possible to inaccessible attachment chambers while being careful to not distort the attachment creation tray would result in inaccurately positioned holes. In these cases, the teeth will not be appropriately prepared, leading to unbonded tooth attachments prone to falling off a patient's tooth mid-treatment. There will also be massive amounts of bonded flash which has been shown to cause undesired tooth movement during clear aligner treatment. Although the punch assembly 201 is useful in many cases, it is not a suitable tool to address all attachment locations and orientations.

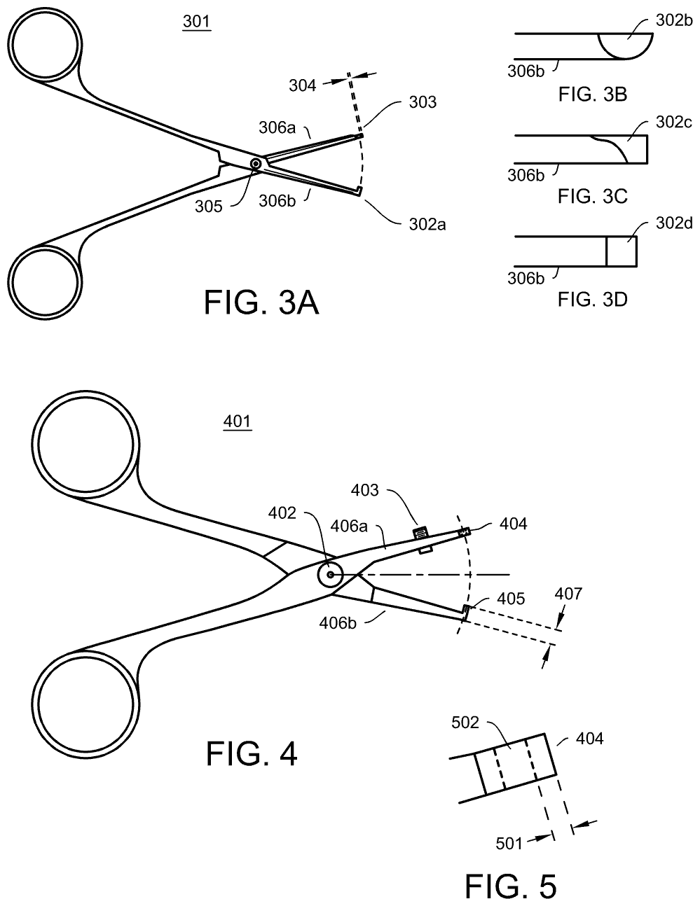

The punch of FIG. 3A better addresses the need for a broadly capable punching tool by adapting a hemostat to create a punch and die assembly 301. A pin inside a bushing 305 allows the punch 302 and die 303 to match up correctly by rotation to the tolerances needed for punching a clean hole. The die jaw 306a is permanently attached to the die 303 as a single piece. Welding, brazing, casting, etc. attaches the die to the jaw. The die has an overhang 304 that is needed to surround the hole geometry and provide a clean cut for the entire perimeter.

The punch jaw 306b has no overhang in length or width beyond the geometry of the punch 302 in this design. The punch 302 has a minimum height to ensure it can be placed inside the concave side of an attachment chamber in even the narrowest areas of an attachment creation tray without causing irreversible distortion. The punch jaw 306b and the punch 302a are a single piece. This punch and die assembly will successfully create the needed openings for the inaccessible attachment chamber locations. However, it is important to optimize the stiffness of the pin/bushing so that the meeting of the punch and die have sufficient tolerances to be well controlled and avoid early wear.

FIG. 3B is a top view of punch jaw 306b of the punch tool 301 having a punch 302b in the shape of a semicircle. The punch jaw terminates in the shape of the punch so there is no punch jaw overhang in length or width.

FIG. 3C is a top view of punch jaw 306b of the punch tool 301 having a punch 302c in the shape of a teardrop. The punch jaw terminates in the shape of the punch so there is no punch jaw overhang in length or width.

FIG. 3D is a top view of punch jaw 306b of the punch tool 301 having a punch 302d in the shape of a square. The punch jaw terminates at the punch so there is no punch jaw overhang in length or width.

In FIG. 4, a second embodiment addresses the need for a universal punch tool 401 with better life. Similarly to FIG. 3A, A pin inside a bushing 402 allows the punch 405 and die 404 to match up correctly to the tolerances needed to create a clean hole. The die jaw 406a and punch jaw 406b are sturdier and more rigid when compared to 301, and the pin/bushing 402 is also bigger to create better punch tolerances and extend the tool life. An optional threaded stop 403 is added to prevent the punch from plunging farther than necessary into the die to reduce wear to the punch and die. 401 is similar to 301 having a punch jaw 406b which terminates at the punch 405 so there is no punch jaw overhang in length or width beyond the shape of the punch.

The combined height of the punch and thickness of the punch jaw measured at the punch is total punch height 407. Total punch height should be small enough to access deep anterior attachments without irreversibly distorting or causing damage to the attachment creation tray. A total punch height of 6 mm has been shown to distort the attachment creation tray when accessing deep anterior attachment chambers. However, in these cases the attachment creation tray rebounded to its initial shape with no apparent damage. A total punch height of 4 mm has been shown to minimally distort the tray when punching deep anterior attachment chambers and retain its effectiveness as a punch. FIG. 5 shows a closeup of the die overhang 501 and the slug passageway 502.

A third embodiment of the design shown in FIGS. 4 and 5, FIGS. 6A-6C show a die 603, and punch 604 are removable and separately attached to the die and punch jaws 601a,b of a specially designed punch tool. Screws 602a,b secure the interchangeable die and punch to the jaws of the punch tool. Other attaching and keying hardware may also be utilized. The punch of this embodiment would have no punch jaw overhang in length or width and a minimum height to ensure it can access deep and anterior attachment chambers without causing irreversible distortion to the attachment creation tray.

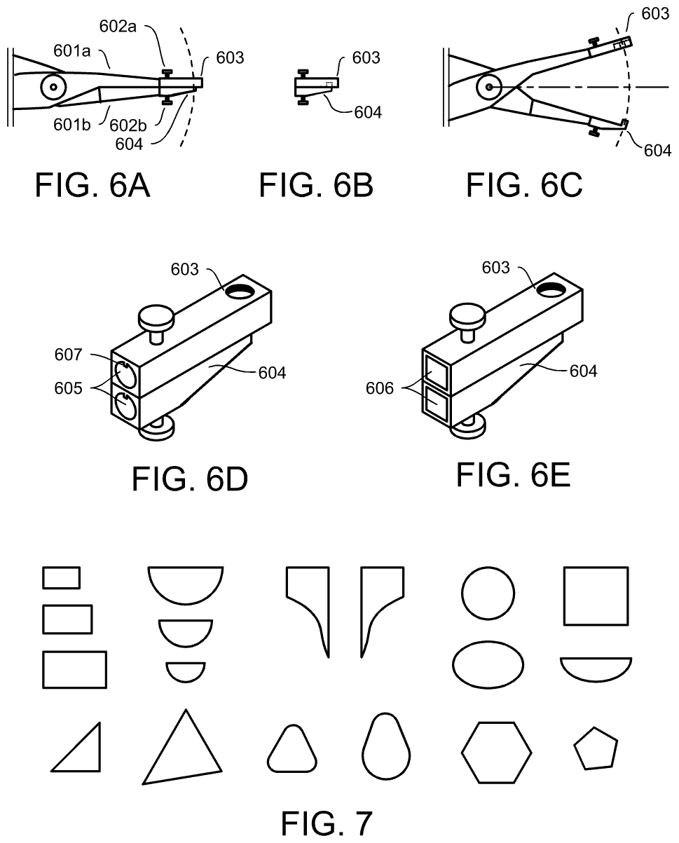

FIGS. 6D, 6E show an isometric view of the punch-die set indicating either a round 605 or

square 606 connection geometry, including a key 607 that is added to the round geometry. Other connection geometries can equally be used. These interchangeable die and punch sets could also be designed to attach to an existing instrument readily available in a typical dental office such as a hemostat.

FIG. 7 shows exemplary punch-die geometries of polygons, squares, circles, ellipses, partial circles, triangles, and the like. They are larger or smaller as needed. The punch-die geometry is defined by the tooth attachment geometry that provides the required tooth movement. The illustration is not restrictive as to the needed geometry.

Generally, the design of the punch will be free of overhang. However, due to difficulties in attaching a punch geometry to the punch jaw, a small amount of overhang may be necessary. The amount would be 0.5 mm or less.

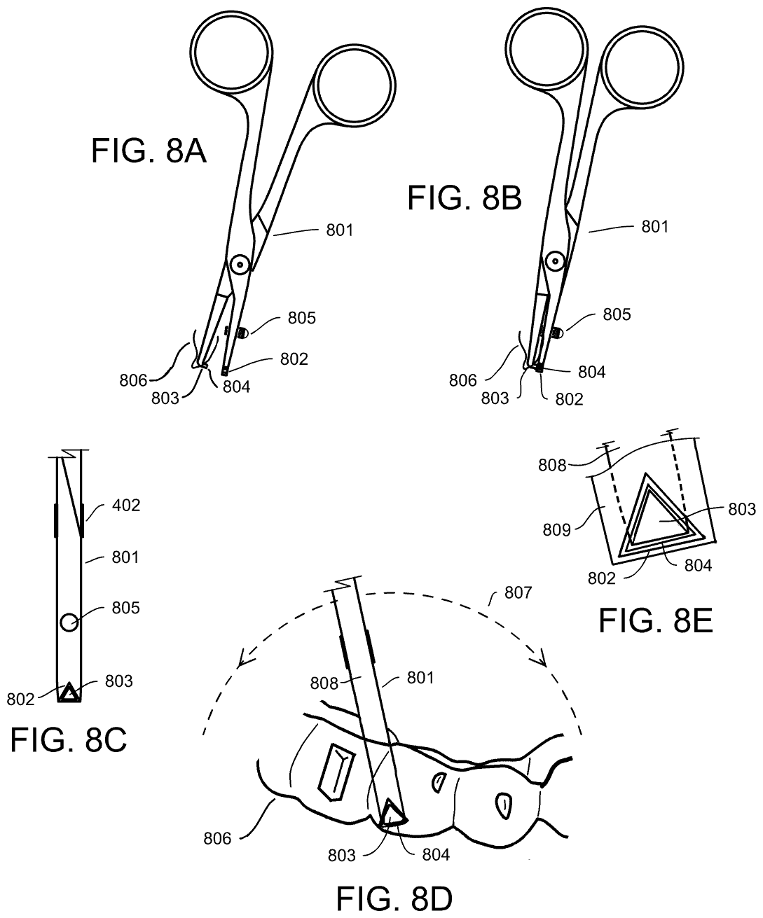

FIGS. 8A-8B shows a preferred orientation for the punch tool 801 where the punch 803 is located inside the attachment creation tray 806, and the die 802 is on the outside of the tray. This will allow the clinician to ‘feel’ the punch seat into the attachment chamber 804 before punching. Indexing the punch tool in this way is similar to following a pilot hole and will ensure the operator has positioned the punch tool in the correct location and orientation prior to punching.

In FIG. 8B, the clearance around the punch and die is about 10%, meaning the punch is about 20% smaller in size. This allows the punch to fit within the attachment chamber and aids in orienting the punch and die correctly. Since the attachment chamber protrudes outwardly from the template, it is far less precise for the punch to rest against the protrusion and the die against a non-protruding side. Therefore, it is preferable to have the die on the outside of the template.

Also, the punch (without overhang) is on the inside of the attachment creation tray which allows improved maneuverability without distorting the attachment creation tray. This simple method ensures a single punch motion can create a clean hole.

FIG. 8C shows a right side view of the punch tool 801. FIG. 8D shows the punch 803 being rotated 807 and indexed into the concave geometry of the attachment chamber 804 and aligned to it. The rotation 807 angle can be up to 170 degrees on anterior teeth and 180 degrees on posterior teeth, which allows a single die-punch set of various shapes to cover most protruding geometry orientations. The ability to maneuver the punch tool in this manner is a distinct advantage of a custom punch tool.

FIG. 8E shows a closeup of the punch 803, punch jaw 808, and attachment chamber 804 of FIG. 8D with the addition of the die jaw 809, and die 802 positioned over the attachment chamber and ready to punch out a hole. A triangular geometry is shown only as an example. A wide variety of punch shapes can be indexed into their matching attachment chamber shapes.

Preferably, the die cutting geometry is a close match to the attachment chamber perimeter geometry. However, this may not be practical in some cases. The number of cutting geometries needed to provide all possible geometries becomes excessive unless the tooth attachment geometry is designed with punch geometry in mind.

To simplify the number of tools, simpler tool geometries can be used to approximate complex tooth attachment geometries. This would include circles, squares, rectangles, ellipses, triangles and the like, in a few different sizes. This would allow reasonable simplicity and still provide high tooth enamel protection from excess bonded flashing and the damage associated with its removal.

Other methods for creating holes in preparation trays potentially are: blades, lasers, heated cutters, drills, small grinders, and milling tools that are operated in 3D space with computer numerical control. However, these solutions are expensive as the 3D cutting movement is challenging due to the variety in shape and position of the tooth attachments. Such solutions have a high initial cost.

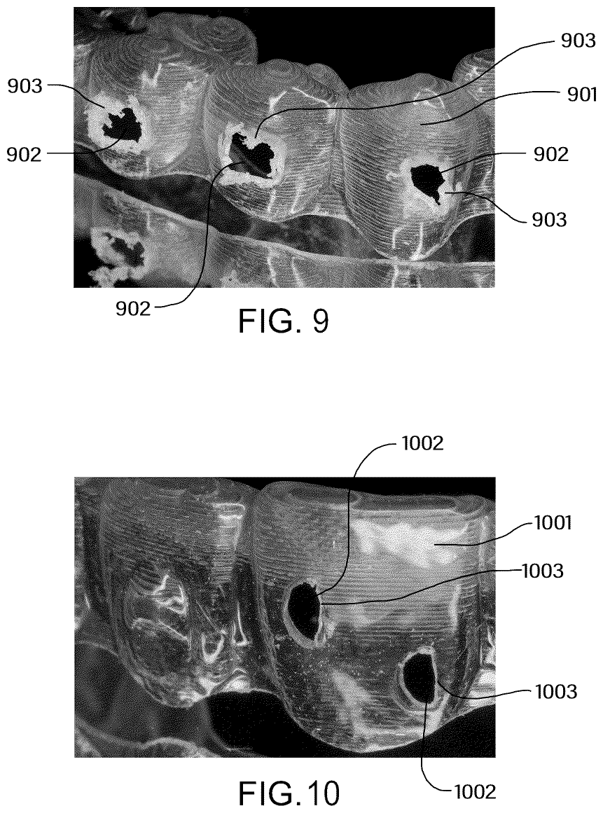

FIG. 9 is a closeup photograph of preparation tray 901 holes 902 created with a dental drill. If a dental drill is used to remove the attachment chambers the resulting holes will never be as precise in shape and size when compared to holes created with a punch. Additionally, heat generated by the dental bur in a dental handpiece melts the plastic of the attachment creation tray as it cuts leaving the edges 903 rough from frayed melted fibers of the plastic. Often these burrs extend into the intaglio of the attachment creation tray and, if not carefully removed, prevent the tray from fully seating against the tooth near the periphery of the holes. In this case, etch and other bonding fluids easily wick into the gaps created near the burrs. Etching and bonding beyond the tooth attachment contact area leads to bonded flash which will reduce the effectiveness of tooth aligners. This bonded flash can only be completely removed from the tooth with a dental drill which increases the risk of damaging tooth enamel and/or altering the attachment shape. Maneuvering a dental drill around the protruding tooth attachment geometry while also engaging the bonded flash is difficult. Tooth attachments are easily altered by a dental drill whose bur can be rotating at speeds as high as 420,000 rpm. In contrast a punch will always cut a clean hole which reduces the risk of etching and bonding beyond the attachment contact area.

In contrast, FIG. 10 is a closeup photograph of a preparation tray 1001 with holes 1002 created using a preparation tray punch. Preparation tray holes created with a punch have clean edges 1003 free of burrs which improves the fit of the preparation tray against the teeth thus reducing the risk of etching and bonding beyond the attachment contact area. A preparation tray punch may also be designed to leave the edges of the holes it creates rolled internally. When placed on the teeth these internally rolled edges would contact the tooth surface acting as a seal to further contain etching and bonding fluids. Holes created with a preparation tray punch are also a more precise match to the future tooth attachment contact area when compared to holes created free hand using a dental drill or blade.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

1. A punching tool designed to make a hole in a tooth attachment creation tray to create a preparation tray for a multi-tray orthodontic movement system utilizing at least one tooth attachment comprising:
A) a punch attached to a punch jaw, said punch is free of overhang,
B) a die attached to a die jaw,
C) said punch jaw and said die jaw rotate about an axis,
D) a punch handle attached to said punch jaw and a die handle attached to said die jaw,
E) said punch having a cutting geometry, said die having an opening larger than said cutting geometry by a perimeter clearance,
F) said tooth attachment creation tray having at least one attachment chamber being the object of said punch,
G) said punch operable to position and orient said cutting geometry within said at least one attachment chamber, said die operable to be positioned around protruding geometry of said at least one attachment chamber,
H) said punch and said die operable by said punch handle and said die handle to create a hole that removes said at least one attachment chamber from said tooth attachment creation tray, and
I) whereby said preparation tray is created from said tooth attachment creation tray.

2. The punching tool according to claim 1, wherein said punch is positioned on the inside of said tooth attachment creation tray.

3. The punching tool according to claim 1, wherein a small amount of overhang less than 0.5 mm is added to said punch jaw.

4. The punching tool according to claim 1, wherein the total punch height is less than 6 mm.5. A method to make at least one hole in a tooth attachment creation tray to create a preparation tray for a multi-tray orthodontic movement system utilizing at least one tooth attachment comprising:
A) providing:
a) a punch attached to a punch jaw, said punch is free of overhang,
b) a die attached to a die jaw,
c) said punch jaw and said die jaw rotate about an axis,
d) a punch handle attached to said punch jaw and a die handle attached to said die jaw,
e) said punch having a cutting geometry, said die having an opening larger than said cutting geometry by a perimeter clearance,
f) said tooth attachment creation tray having at least one attachment chamber being the object of said punch,
B) positioning and orienting said cutting geometry within said at least one attachment chamber,
C) positioning and orienting said die around protruding geometry of said at least one attachment chamber,
D) operating said punch handle and said die handle to create a hole by removing said at least one attachment chamber from said tooth attachment creation tray, and
E) whereby said preparation tray is created from said tooth attachment creation tray.
